(19) United States
(12) Patent Application Publication
(10) Pub. No.: US 2024/0423241 A1
(43) Pub. Date: Dec. 26, 2024

(54) HIGH PLANT PUFA FISH FOOD

(71) Applicant: CAN TECHNOLOGIES, INC., Wayzata, MN (US)

(72) Inventors: Jeongwhui HONG, Twin Falls, ID (US); Diliara IASSONOVA, Maple Grove, MN (US); Brian Christopher SMALL, Twin Falls, ID (US)

(73) Assignee: CAN TECHNOLOGIES, INC., Wayzata, MN (US)

(21) Appl. No.: 18/708,116

(22) PCT Filed: Nov. 8, 2022
(86) PCT No.: PCT/US2022/079475

§ 371 Date: May 7, 2024

Related U.S. Application Data
(60) Provisional application No. 63/276,704, filed on Nov. 8, 2021.

(51) Int. Cl. A23K 10/30; A23K 40/30; A23K 50/80

(52) U.S. Cl. CPC A23K 10/30; A23K 40/30; A23K 50/80

(57) ABSTRACT

Fish feed and methods to increase weight gain in farmed fish comprising providing a feed composition to said fish, wherein said feed composition comprises oil derived from a genetically modified oilseed crop plant, wherein the oil from the genetically modified oilseed crop plant comprises EPA, DHA and DPA.

### CROSS-REFERENCE TO RELATED APPLICATIONS

This application claims the benefit of U.S. Provisional Patent Application No. 63/276,704, filed Nov. 8, 2021, which is incorporated by reference in its entirety.

### BACKGROUND OF THE INVENTION

Marine microalgae that are able to synthesize EPA and DHA directly are the world's primary producers of EPA and DHA, which are then accumulated through the aquatic food webs. For this reason, fish is considered the primary dietary source of n-3 LC-PUFA, EPA and DHA for humans (Bentancor et al., 2017; Osmond and Colombo, 2019). Many health agencies worldwide recommend 500-1000 mg/day of total EPA+DHA per day for reducing cardiovascular disease (Aranceta and Pérez-Rodrigo, 2012).

Over the past decade, dramatic increases in fishmeal (FM) and fish oil (FO) prices have driven feed manufacturers across the aquaculture industry to lower the use of FM and FO in aquafeed for virtually all farmed fish species. For salmonid diets, this has meant a reduction of marine ingredients in the diet by as much as 60% (Ytrestoyl et al., 2015). The transition away from marine ingredients toward plant-based ingredients has afforded the industry the ability to increase production while reducing feed costs and the impact of aquaculture on wild fisheries. However, it is not without costs, in that it has resulted in a substantial reduction in the levels of omega-3 long-chain polyunsaturated fatty acids (n-3 LC-PUFA), specifically eicosapentaenoic acid (EPA, 20:5n-3) and docosahexaenoic acid (DHA, 22:6n-3) in fish tissues. Therefore, there is a need to produce more sustainable oil sources that can be used to meet the increasing demand for oil ingredients high in n-3 LC-PUFA.

### SUMMARY OF THE INVENTION

Provided herein is fish feed and methods of use. In particular, provided herein is fish feed materials in which at least some, or all, of the long-chain omega-3 fatty acids (i.e., those of 20 or more carbon atoms) are derived from oilseed plants, such as genetically modified oilseed plant lines rather than from marine oils such as fish oils. In some embodiments, the fish feeds described and used herein do not contain marine oil and/or fish meal.

One aspect provides a method to increase weight gain in farmed fish comprising providing a feed composition to said fish, wherein said feed composition comprises 6% to 40% w/w of an oil derived from a genetically modified oilseed crop plant, wherein the oil from the genetically modified oilseed crop plant comprises at least 10% to 40% EPA, DHA and DPA. In one aspect, the weight gain is increased by 10-20% as compared to control farmed fish not fed the feed composition comprising oil from the genetically modified oilseed crop plant.

One aspect provides a method to provide a higher final weight of farmed fish comprising providing a feed composition to said fish, wherein said feed composition comprises 6% to 40% w/w of an oil derived from a genetically modified oilseed crop plant, wherein the oil from the genetically modified oilseed crop plant comprises at least 10% to 40% EPA, DHA and DPA. In one aspect, the final weight is increased by at least 9.5% to 22% as compared to control fish not fed the feed composition comprising oil from the genetically modified oilseed crop plant.

Another aspect provides a method to increase specific growth rate (SGR) of farmed fish comprising providing a feed composition to said fish, wherein said feed composition comprises 6% to 40% w/w of an oil derived from a genetically modified oilseed crop plant, wherein the oil from the genetically modified oilseed crop plant comprises at least 10% to 40% EPA, DHA and DPA. In one aspect, the SGR is increased by at least 2-4%, including 2.8%, as compared to control fish not fed the feed composition comprising oil from the genetically modified oilseed crop plant.

One aspect provides a method to provide DHA to farmed fish fillets comprising providing a feed composition to said fish, wherein said feed composition comprises 6% to 40% w/w of an oil derived from a genetically modified oilseed crop plant, wherein the oil from the genetically modified oilseed crop plant comprises at least 10% to 40% EPA, DHA and DPA, wherein said EPA and DPA from said plant oil is converted to DHA that is deposited in said fillets of said fish.

In one aspect, the added oil in the feed composition comprises up to 50% added oil from plant oil. In another aspect, the added oil in the feed composition is 100% added oil from plant oil. In one aspect, the oil from the genetically modified oilseed crop plant comprises at least 38.6% EPA, DHA and DPA. In another aspect, the oil from the genetically modified oilseed crop plant comprises at least 12.9% EPA, DHA and DPA.

In one aspect, the feed composition is provided to said fish from first feeding to harvest. In another aspect, the feed composition is provided to said fish for 6 to 36 months, including 12 months. In one aspect, the feed composition is provided to said fish at starting weight of from about 10-30 g to a finishing weight about 800-1200 g.

In another aspect, the oil from the genetically modified oilseed crop plant comprises at least 7.5% to 26.2% w/w EPA, 0.7% to 8.2% w/w DHA and 3.5% to 10.4% DPA. In one aspect, the feed composition does not comprise more than 50% added marine oil. In another aspect, no more than 20% marine oil is present in the feed composition.

In one aspect, the fish are salmonids. In one aspect, the salmonids are salmon, trout or chars. In another aspect, the salmonids are trout or salmon.

In one aspect, the feed composition is powdered, flaked or pelleted. In one aspect, the powder, flakes or pellets are oil coated.

### BRIEF DESCRIPTION OF THE DRAWINGS

FIG. 1. Relative mRNA expression (normalized against Arp) of genes involved in elongation (elovl2 and elovl5), desaturation (d5fad and d6fad) and β-oxidation (Acyl-Coa oxidase) in liver of rainbow trout fed experimental diets for 52 weeks. Mean±SE (n=9 fish per treatment except diet 2; n=6) in the same row that share the same superscript are not statistically different (P>0.05). 2Three fish from each tank were used for gene expression. Abbreviations: Elovl2: Elongation of very long chain fatty acids-like 2; Elovl5:Elongation of very long chain fatty acids-like 5; Δ5 fad: Delta-5 fatty acid desaturase; Δ6 fad: Delta-6 fatty acid desaturase

FIG. 2. Relative mRNA expression (normalized against Arp) of genes involved in elongation (elovl2 and elovl5), desaturation (d5fad and d6fad) and β-oxidation (Acyl-Coa oxidase) in muscle of rainbow trout fed experimental diets for 52 weeks. Mean±SE (n=9 fish per treatment except diet 2; n=6) in the same row that share the same superscript are not statistically different (P>0.05). 2Three fish from each tank were used for gene expression. Abbreviations: Elovl2: Elongation of very long chain fatty acids-like 2;Elovl5: Elongation of very long chain fatty acids-like 5; Δ5 fad: Delta-5 fatty acid desaturase; Δ6 fad: Delta-6 fatty acid desaturase

FIG. 3. Mean body weight over time of rainbow trout fed experimental diets differing in oil source for 52 weeks.

### DETAILED DESCRIPTION OF THE INVENTION

The following description provides exemplary embodiments only, and is not intended to limit the scope, applicability, or configuration of the disclosure. Rather, the following description of the exemplary embodiments will provide those skilled in the art with an enabling description for implementing one or more exemplary embodiments. It will be understood that various changes may be made in the function and arrangement of elements without departing from the spirit and scope of the disclosure as set forth in the appended claims.

Specific details are given in the following description to provide a thorough understanding of the embodiments. However, it will be understood by one of ordinary skill in the art that the embodiments may be practiced without these specific details. For example, systems, processes, and other elements in the instant disclosure may be shown as components in block diagram form in order not to obscure the embodiments in unnecessary detail. In other instances, well-known processes, structures, and techniques may be shown without unnecessary detail in order to avoid obscuring the embodiments.

Alternative oil sources are needed to meet the growing demand for highly digestible sources of energy and fatty acids in fish feeds. Historically, marine oils have met this need; however, diminishing supplies cannot continue to meet the demand of a rapidly growing aquaculture industry. Furthermore, the primary dietary source of long-chain polyunsaturated fatty acids for humans is seafood, but for farmed fish to meet the dietary LC-PUFA requirements of human consumers, aquafeeds must contain oil sources high in these fatty acids, such as fish oil (FO). Provided herein are the effects of Latitude™ oil (Transgenic canola) inclusion in fish feeds on growth performance, non-specific immune responses, histology, and fillet omega-3 fatty acid contents in rainbow trout, Oncorhynchus mykiss, fed for 52 weeks. Latitude oil (LO) is highly digestible (93%), containing omega-3 fatty acids eicosapentaenoic acid (EPA, C20:5n-3), docosapentaenoic acid (DPA, C22:5n-3) and docosahexaenoic acid (DHA, C22:6n-3). Three isonitrogenous (49.8%), isolipidic (20.4%) and isocaloric (24.2 MJ/kg) diets differing by lipid source (0, 8, or 16% LO, replacing FO and poultry fat) were fed over an entire production cycle beginning with 19 g juvenile fish. At the end of 52-week feeding trial, final body weight, weight gain and specific growth rate of fish fed 8% LO (LO-8) and 16% LO (LO-16) diets were significantly higher than those fed the 0% LO (LO-0) diet (P<0.05).

Inclusion of LO enhanced the omega-3 fatty acid concentrations of EPA and docosahexaenoic acid (DHA, 22:6n-3) in the fillet. Fillet DHA content of fish fed the LO-8 and LO-16 diets were similar to those of fish fed the LO-0 diet. As these diets had lower DHA content, this suggests dietary EPA and DPA from LO was converted to DHA and deposited in the fillet. This is supported by increased expression of genes involved in fatty acid elongation, desaturation and beta oxidation in both liver and muscle of fish fed LO (P<0.05). Total EPA+DHA content of the edible fillet ranged between 1079 to 1241 mg/100 g across treatments, each providing the recommended daily intake for human consumption. Overall, this study demonstrated that LO is a highly digestible lipid source suitable for meeting the fatty acid requirements of rainbow trout, as well as consumer expectations for fillet omega-3 fatty acid content.

### Definitions

In describing and claiming the invention, the following terminology will be used in accordance with the definitions set forth below. Unless defined otherwise, all technical and scientific terms used herein have the same meaning as commonly understood by one of ordinary skill in the art to which this invention belongs. Any methods and materials similar or equivalent to those described herein can be used in the practice or testing of the present invention. Specific and preferred values listed below for radicals, substituents, and ranges are for illustration only; they do not exclude other defined values or other values within defined ranges for the radicals and substituents.

As used in this specification and the appended claims, the singular forms “a,” “an,” and “the” include plural references unless the context clearly dictates otherwise. By way of example, “an element” means one element or more than one element. Similarly, references to “the method” includes one or more methods, and/or steps of the type described herein and/or which will become apparent to those persons skilled in the art upon reading this disclosure and so forth.

As used herein, the term “about” means acceptable variations within 20%, such as within 10% or within 5% of the stated value.

The term “oil” as used herein refers to a substance formed primarily of fatty acids. An oil herein may be either liquid or solid at room temperature and may be in liquid or solid form (e.g., a dry fat). Oils are formed primarily of fatty acids, for instance in triglyceride or phospholipid (e.g., lecithins) form. Examples of oils herein include various vegetal oils such as Brassica oils as well as marine oils such as fish oil or krill oil, animal fats such as poultry fat, and phospholipids such as soy lecithin. Oils may also include other compounds often associated with fats such as sterols, e.g., cholesterol, or tocopherols.

A “fatty acid” herein refers to a molecule comprising a hydrocarbon chain and a terminal carboxylic acid group. As used herein, the carboxylic acid group of the fatty acid may be modified or esterified, for example as occurs when the fatty acid is incorporated into a glyceride or a phospholipid or is attached to another molecule such as acetyl-CoA (e.g., COOR, where R refers to, for example, a carbon atom). Alternatively, the carboxy lic acid group may be in the free fatty acid or salt form (i.e., COO″ or COOH).

A “saturated” fatty acid is a fatty acid that does not contain any carbon-carbon double bonds in the hydrocarbon chain. An “unsaturated” fatty acid contains one or more carbon-carbon double bonds. A “polyunsaturated” fatty acid contains more than one such carbon-carbon double bond while a “monounsaturated” fatty acid contains only one carbon-carbon double bond. Carbon-carbon double bonds may be in one of two stereo configurations denoted “cis” and “trans.” Naturally occurring unsaturated fatty acids are generally in the “cis” form.

Unsaturated fatty acids may, for example, be of the “omega-6” (or n6 or co6) or “omega-3” (n3 or co3) type. Omega-6 fatty acids have a first double bond at the sixth position from the methyl end of the fatty acid chain while omega-3 fatty acids have a first double bond at the third position from the methyl end of the chain. The term “long-chain” when applied to an omega-3 or omega-6 fatty acid means having a chain of 20 carbons or more.

Fatty acids found in plants and oils described herein may be incorporated into various glycerides. The terms “triacylglycerol,” “triglyceride,” and “TAG” are used interchangeably herein to refer to a molecule comprising a glycerol that is esterified at each of its three hydroxyl groups by a fatty acid and thus, comprises three fatty acids. The terms “diacylglycerol,” “diglyceride,” and “DAG” refer to a molecule comprising a glycerol esterified by a fatty acid at only two of its three available hydroxyl groups, such that it contains only two fatty acids. Likewise, the term “monoglyceride” refers to a glycerol modified by a fatty acid at only one of the available three hydroxyl groups so that it comprises only one fatty acid.

Fatty acids found in plants and oils described herein may also be incorporated into various “phospholipids,” abbreviated “PL” herein. Phospholipids are molecules that comprise a diglyceride, a phosphate group, and another molecule such as choline (“phosphatidyl choline;” abbreviated “PC” herein), ethanolamine (“phosphatidyl ethanolamine;” abbreviated “PE” herein), serine “phosphatidyl serine;” abbreviated “PS” herein), or inositol (“phosphatidyl inositol;” abbreviated “PI” herein). Phospholipids, for example, are important components of cellular membranes.

Fatty acids described herein include those listed in the table below along with abbreviations used herein and structural formulae. According to the Table below, the naming convention comprises the number of carbons in the fatty acid chain (e.g., C16, C18, etc.) followed by a colon and then the number of carbon-carbon double bonds in the chain, i.e., 0for a saturated fatty acid comprising no double bonds or 1, 2, 3, etc. for an unsaturated fatty acid comprising one, two, or three double bonds.

Fatty acid nomenclature

| Fatty acid name (abbreviation) | Formula |
|---|---|
| Lauric acid (La) | C12:0 |
| Myristic acid (M) | C14:0 |
| Palmitic acid (P) | C16:0 |
| Palmitoleic acid (Po) | C16:1 |
| Stearic acid (S) | C18:0 |
| Oleic acid (O) | C18:1 |
| Linoleic acid (L) | C18:2 |
| Linolenic acid (La) | C18:3 |
| Arachinic acid (A) | C20:0 |
| Gondoic (G) | C20:1 |
| Eicosapentaenoic acid (EPA) | C20:5 |
| Behenic acid (B) | C22:0 |
| Erucic acid (E) | C22:1 |
| Docosapentaenoic acid (DPA) | C22.5 |
| Docosahexaenoic acid (DHA) | C22:6 |
| Lignoceric acid (Li) | C24:0 |

The levels of particular types of fatty acids may be provided herein in percentages out of the total fatty acid content of an oil or may be provided a percentage of the feed composition as a whole (w/w). The fatty acid composition of an oil can be determined by methods well known in the art. The American Oil Chemist's Society (AOCS) maintains analytical methods for a wide variety of tests performed on vegetable oils. Hydrolysis of the oil's components to produce free fatty acids, conversion of the free fatty acids to methyl esters, and analysis by gas-liquid chromatography (GLC) is the universally accepted standard method to determine the fatty acid composition of an oil sample. The AOCS Procedure Ce 1-62 describes the procedure used.

As used herein, reference to an oilseed “plant” or “plants” includes the plant and its progeny, such as its Fi, F₂, F₃, F₄, and subsequent generation plants. As used herein, a “line” or “breeding line” is a group of plants that display little or no genetic variation between individuals for at least one trait, such as a particular gene mutation or set of gene mutations. Such lines may be created by several generations of self-pollination and selection or by vegetative propagation from a single parent using tissue or cell culture techniques. A “variety” refers to a line that is used for commercial production and includes hybrid and open-pollinated varieties.

An “oilseed plant” or “oilseed crop plant” as used herein encompasses a variety of plant species that may be used in part as a source of oils. For example, the plant may include any of Brassica, flax, linseed, hemp, walnut, evening primrose, soy, sunflower, cotton, corn, olive, safflower, cocoa, peanut, hemp, camelina, crambe, palm, coconut, sesame, castor bean, lesquerella, tallow, sheanuts, tungnuts, kapok fruit, poppy, jojoba, perilla, or groundnut species. Furthermore, in some embodiments, the oilseed plant is a Brassica species or Camelina species. Brassica plants may include, for example, B. napus, B. juncea, and B. rapa (rapeseed) species, while Camelina species include, for example, C. sativa.

The term “oil from an oilseed plant” and related terms as used herein refer to an oil derived from seeds or other parts of an oilseed crop plant. In some embodiments, the oil also may be chemically treated or refined in various ways, for example by degumming, refining, bleaching, dewaxing, and/or deodorizing.

The term “modified oilseed plant oil” as used herein refers to a plant species from which the oil is derived has been genetically modified to produce long-chain omega-3 fatty acids such as EPA, DPA, and/or DHA and is, accordingly, referred to as a or an “oil from a genetically modified oilseed plant” or by similar terms. The terms modified or genetically modified are used here to distinguish the long-chain omega-3 fatty acid producing plants, or the oils derived from such plants from other plant lines that do not produce long-chain omega-3 fatty acids. If the oilseed plant is, for example, a Brassica or Camelina species, then the term “modified Brassica oil” or “modified Camelina oil” may be used.

In contrast to a “modified Brassica oil” such as a modified rapeseed oil, the general term “rapeseed oil” without including the adjective “genetically modified” or “modified,” unless specifically clarified otherwise, refers to an oil from seeds or other parts of a rapeseed plant that has not been genetically modified to produce long-chain omega-3 fatty acids. Note that the plant from which such a “rapeseed oil” or other vegetal oil (e.g., soy oil, linseed oil, etc.) is derived may certainly be genetically modified in other ways, such as for herbicide resistance or to modify the proportions of certain fatty acids in its oil. But the plant is not modified such that it produces long-chain omega-3 fatty acids.

The term “oil component” as used herein refers to a portion of a fish feed comprising exclusively or predominately oils. The oil component may be comprised of a single oil such as a DHA and EPA containing oil from a modified Brassica plant or other modified plants. Alternatively, the oil component may be a mixture of any number of oils from other plant or animal sources including DHA and EPA containing oil from a modified Brassica plant or other modified plants. It may also contain modified or processed oils such as dry fats or hard fats.

A “marine oil” refers to a material comprising at least 80% of an oil derived from marine species such as fish, krill, or algae. In some embodiments, the marine oil may comprise a product stream obtained from a refining process and/or a concentration process carried out with an oil derived from marine species such as fish, krill, or algae. Marine oil does include materials that contain a residual or minor amount of oil derived from marine species, such as fish meal.

An “animal fat” or “animal oil” refers to an oil, which may be solid at room temperature, derived from animals, such as poultry, beef, pork, fish, and the like. In some embodiments, where the fish feed comprises an animal fat but not a marine oil, the animal fat is not derived from a marine species, such as fish or krill, but from a terrestrial species such as poultry or beef.

A “dry fat” is an oil, such as a partially or fully hydrogenated oil, that is provided in a dry form, such as in a powder or a low-dust particle. The oil in a dry fat may include fully hydrogenated plant oil such as rapeseed oil (e.g., high erucic acid rapeseed oil, canola oil), palm oil, and fully hydrogenated cottonseed or soy bean oil.

An “ingredient mixture” or “set of ingredients” as used herein when pertaining to ingredients for a fish feed material refer interchangeably to the list of ingredients to be included in the fish feed material, in the appropriate weight percentages out of the total ingredient list. The ingredients in the set of mixture may be added at different times or stages during production of the final fish feed material. The weight percentages of ingredients in the set of ingredients may differ from those in the final fish feed material due to changes in moisture content or oil leakage or incomplete absorption of materials added to the surface of the fish feed material, for example.

A “pellet” as used herein, for example, to refer to fish feed compositions, which is a solid particle that may be of any size or shape suitable for use as a fish feed. Pellets are often mechanically extruded into roughly cylindrical or spherical shapes by an extruder device, but they may also be prepared as flakes or other flat shapes, for example, and their length and diameter may also vary depending upon what is desirable for storage, transport, environmental concerns, and the type of fish they are intended for feeding. Fish feeds may also be provided in “powder” form, i.e., in fine, small particles.

Growth rate is expressed as percentage increase in body mass from day to day (Specific Growth Rate, SGR). The SGR does not take into account the amount of feed fed to obtain growth. It is a measure of growth rate only.

Another factor is how efficiently the fish grow on the feed. Fish growth is in practical terms protein deposition in the muscle (growth of muscle mass).

The term “fish feed” as used herein includes compositions as described below. Typically, fish feed includes fish meal as a component. Suitably, fish feed is in the form of flakes or pellets, for example extruded pellets. In addition to the plant derived oil described below, fish feed comprises one or more of: sources of protein, carbohydrate and lipid (for example, fish meal, fish oil,, animal meal (for example blood meal, feather meal, poultry meal, chicken meal and/or other types of meal produced from other slaughterhouse waste), animal fat (for example poultry oil), vegetable meal (e.g. soya meal, lupin meal, pea meal, bean meal, rape meal and/or sunflower meal), vegetable oil (e.g. rapeseed oil, soya oil, including modified forms obtained from genetically modified plants which are modified to produce fatty acids), gluten (e.g. wheat gluten or corn gluten) and added amino acids (e.g. lysine)); vitamin(s); mineral(s); and pigment (e.g., canthaxanthin, astaxanthin).

As used herein the term “comprising,” “having” and “including” and the like are used in reference to compositions, methods, and respective component(s) thereof, that are present in a given embodiment, yet open to the inclusion of one more or more unspecified elements. The term “including” is used herein to mean, and is used interchangeably with, the phrase “including but not limited to.”

### Oils from Modified Oilseed Crop Plants

Vegetal oils containing long-chain omega-3 fatty acids such as EPA, DPA, and DHA may come from a variety of oilseed crop plants, including, for example, any of Brassica, flax, linseed, hemp, walnut, evening primrose, soy, sunflower, cotton, corn, olive, safflower, cocoa, peanut, hemp, camelina, crambe, palm, coconut, sesame, castor bean, lesquerella, tallow, shea nuts, tungnuts, kapok fruit, poppy, jojoba, perilla, or groundnut species. In some embodiments, the oilseed plant is a Brassica species or Camelina species. Among Brassica plants are, for example, B. napus, B. juncea, and B. rapa (rapeseed) species, while Camelina species include, for example, C. sativa.

In general, the plants are modified to express the enzymes needed for production of EPA, DPA, and DHA from precursor fatty acids. The specific enzymes expressed in the plants may differ, for example, as there are multiple enzymatic pathways that could be used for expression of these fatty acid species.

The actual percentage of the total oil from the plants that consists of EPA, DPA, or DHA may also vary. But, in some embodiments, the modified oilseed crop plant oil contains at least 7.5% to 26.2% EPA, such as, for example 7.5-16% EPA or 8-15% EPA. In some embodiments, the modified oilseed plant oil comprises 7.5-8%, 8-9%, 9-10%, 10-11%, 11-12%, 12-13%, 13-14%, 14-15%, 15-16%, 16-17%, 17-18%, 18-19%, 19-20%, 20-21%, 21-22%, 22-23%, 23-24%, 24-25%, 25-26% or >26.2% EPA. In some embodiments, the oilseed plant oil also comprises DPA. In some embodiments, the modified oilseed plant oil comprises at least 3.5-10.4% DPA, such as at least 3.5% DPA, such as 3.5-4% DPA, 4-5% DPA, 5-6% DPA, 6-7% DPA, 7-8% DPA, 8-9% DPA, 9-10% DPA or >10% DPA. In some embodiments, the modified oilseed crop plant also is engineered to produce DHA. In some embodiments, the resulting oil contains at least 0.7-8.2% DHA, such as at least 0.7% DHA, such as 0.7-1%, 1-2%, 2-3%, 3-4%, 4-5%, 5-6%, 6-7%, 7-8% or >8.2% DHA.

In some embodiments, the EPA+DHA content of the oil is, for example, at least 8%, such as 8-35%, such as 8-30%, such as 8-15%, such as 8-10%, such as 10-12%, such as 10-30%. In some embodiments, the EPA+DHA content of the oil is tailored to a specific percentage by mixing the oil from the modified plants with oil from plants of the same or similar species that do not produce long-chain omega-3 fatty acids. This way, for instance in some embodiments, the amount of EPA and DHA can be controlled without significantly altering the percentages of other fatty acids in the oil.

In some embodiments, the amount of EPA+DPA+DHA in the oil is, for example, at least 10-40%, such as between 10 and 40%, such as 10-30%, such as 12-20%, such as 14-20%, such as 10-15%, 15-20% or >40%, including 38.6% and 12.9%.

In some embodiments, the modified oilseed crop plants may encompass plants described in or prepared using methods described in WO 2016/075327, which describes EPA and DHA producing Brassica lines and how to produce such lines, among other embodiments. In some embodiments, the modified oilseed crop plants may encompass plants described in or prepared using methods described in WO 2015/089587, which describes EPA and DHA producing oilseed plants and how to produce such lines, among other embodiments. In some embodiments, the modified oilseed crop plants may encompass plants described in or prepared using methods described in WO 2004/071467, which describes EPA and DHA producing Brassica lines and how to produce such lines, among other embodiments. In some embodiments, the modified oilseed crop plants may encompass plants described in or prepared using methods described in U.S. Pat. No. 7,807,849 B2, which describes EPA and DHA producing Arabidopsis lines and how to produce such lines. In some embodiments, the modified oilseed crop plants may encompass plants described in or prepared using methods described in WO 2013/153404, which describes EPA and DHA producing Camelina lines and how to produce such lines. All of these documents are incorporated by reference herein for their disclosures of modified plant lines and how to produce such lines.

Methods to prepare plant oil from oilseed plants, including genetically modified oilseed plants, are available to an art worker, such as expeller-pressed oil using conventional canola seed crushing process that includes tempering, flaking, flake conditioning, expeller pressing and filtering.

### Fish Feed

In some embodiments, a fish feed may comprise a set of ingredients comprising nutrients such as fish meal, soy meal, cereals, binders such as starches, appropriate vitamins and minerals, an ingredient such as glycerol monostearate, and an oil component.

In some embodiments, oil from modified oilseed plants is the only significant source of EPA and DHA in the oil component or fish feed. For example, use of such oil may eliminate the need to include marine oil in the fish feed and thus, the fish feed and oil component in some embodiments contains no marine oil. In other embodiments, the fish feed formulation may include residual marine oil that is a component of fish meal used in the set of ingredients, but not contain any additional or supplemental marine oil in the oil component or set of ingredients. In other embodiments, the oil from the modified oilseed plants may be mixed with marine oil to reduce the percentage of EPA and DHA in the fish feed from marine sources, but not to eliminate it.

In some embodiments, a fish feed set of ingredients is prepared for use in a particular region of the planet and its contents are adjusted to the needs of the fish in that region and/or to what is typical for the diet of fish in the region. Thus, for example, fish feeds intended for use in areas such as Norway or Scotland may contain a different percentage of EPA+DHA or of total long-chain omega-3 fatty acids than fish feeds intended for areas such as Chile or Canada. Actual percentages of different oil components in fish feeds may also vary seasonally or from year to year due to natural variations.

In some embodiments, the oil component comprises no EPA or DHA derived from marine oil or marine oil containing materials such as fish meal. For example, in some embodiments, the fish feed contains no marine oil. In some embodiments, the oil component contains additional oil materials such as a non-marine animal fat, such as poultry fat, pork fat, or beef fat, other vegetal oils derived from plants not engineered to produce EPA or DHA such as linseed oil, soy oil, sunflower oil, palm oil, or Brassica oil e.g., a rapeseed (e.g., canola) oil. In some embodiments, the oil component comprises up to 15% of any of the above oils, such as 0-15% or 0-10% non-marine animal fat, such as 5-15%, 7-13%, 9-11%, or 10-12% non-marine animal fat. In some embodiments, the oil component comprises 0-15% or 0-10% rapeseed oil, such as 5-15%, 7-13%, 9-11%, or 10-12%. In some embodiments, the oil component comprises 0-15% or 0-10% soy oil, such as 5-15%, 7-13%, 9-11%, or 10-12%. In some embodiments, the oil component comprises 0-10% linseed oil, such as 2-8%, 4-8%, or 4-7%.

Further, in some embodiments, the oil component comprises up to 15% lecithin. In some embodiments, the oil component comprises 5-15% lecithin, such as 8-15%, or 10-13%, or 10-12% lecithin. In some embodiments the lecithin is soy lecithin. The oil component may also contain one or more dry fat materials such as a fully hydrogenated vegetal oil. In some embodiments, a fish feed pellet is prepared in which the dry fat is added after extrusion into pellet form, such as at the stage of coating the pellet. In some embodiments, the oil component comprises up to 5% dry fat, such as 1-5%, 1%, 2%, 3%, 4%, or 5% dry fat.

The actual mixture of the oil from the modified oilseed crop plants to other vegetal oils in the set of ingredients may vary depending upon the percentage of EPA+DHA and/or the percentage of EPA+DPA+DHA in the modified plant oil. For example, if a particular EPA+DHA percentage is desired, then an oil comprising 8.5% EPA+DHA should be at a higher percentage in the oil component than an oil comprising 13.5% EPA+DHA. This can be adjusted by mixing the oil from the modified oilseed crop plant with an oil from the same or similar plant species that has not been modified to produce EPA and DHA. Similarly, if a particular percentage of EPA+DPA+DHA is desired, then an oil comprising 12.5% EPA+DPA+DHA should be at a higher percentage in the oil component than an oil comprising 17.5% EPA+DHA.

In some embodiments, the oil component comprises 0-5% soy oil, such as 1%, 2%, 3%, 4%, or 5% In some embodiments, the oil component comprises 0-5% linseed oil, such as 1%, 2%, 3%, 4%, or 5%.

Further, in some embodiments, the oil component comprises no added lecithin. In other embodiments, the oil component comprises 0-15% lecithin. In some embodiments, oil component comprises 0-5% lecithin, such as 1%, 2%, 3%, 4%, or 5% lecithin. In some embodiments the lecithin is soy lecithin.

### Methods of Making Fish Feed Pellets

The oils predominately used in the preparation of fish feeds are liquid at ambient temperatures. If a significant quantity of such oil is included in the feed components prior to their extrusion into pellets, then the oil interferes with the extrusion process and the pellets possess relatively low strength. Therefore, the oil component of a fish feed is often added to the preformed pellets after they are already formed. See e.g., WO 98/49904. As noted above, fish feed pellets typically contain a number of ingredients to suit the nutritional needs of the fish. The pellets may be prepared from a set of ingredients that includes the oil component discussed above along with meal, such as fish meal, soy meal, or animal meat meal or a combination of two or more of those meals, cereals such as wheat, barley, gluten meal, or corn. A starch may be included, in part to act as a binder. Appropriate vitamins and minerals may be added. Certain lipid-based emulsifiers may also be included in the set of ingredients, such as a mono-or diglyceride such as glycerol monostearate. In some embodiments, the emulsifier is solid at room temperature and atmospheric pressure but may become liquid upon heating or increased pressure.

To prepare fish feed in extruded pellets, for example, components of the set of ingredients may be mixed, either at ambient temperature or upon heating and/or added pressure, for example in a pre-conditioning device which may continuously stir or agitate the mixture and provide heat as well as water or steam to facilitate mixing. In some cases, some of the oil component, or simply a small portion of another oil, may be added to the mixture at this stage while some of the oil component may be held back to be added during pre-conditioning or to the mixture during or after extrusion. For example, in a preconditioning process, the temperature may be raised to, for example, 75-95° C., and water or steam may be added to a moisture content of 5-30% by weight of the total set of ingredients contents.

The pre-conditioned mixture may then be extruded to form porous pellets, for example by being directed through an extruder. The ultimate shape and form of the pellets may depend on the design of the extruder used. For instance, extruders may have a single-or twin-screw design. Where such extruders are used, the final product may be affected by the screw and barrel profile and screw speed, as well as by the temperature and moisture content of the processed fish feed material entering the extruder.

As noted above, it is possible to add all of the oil component upon the initial mixing, or alternatively some, all, or a portion of, the oil component may be added to the pellets during or after extrusion. For example, the oil component may be absorbed into porous pellets. For example, pellets may be mixed with 0.05-1 part per weight of the oil component, 0.1-0.5 parts per weight, or 0.3-0.5 parts per weight. The oil component may be absorbed immediately after extrusion or, alternatively, after the pellets have been dried. The oil component may be added by spraying, coating, or dipping, such as in a mixing device. The pellets may also be vacuum coated with the oil component as in WO98/49904. Typically, components of the set of ingredients such as dry fat are added after extrusion, for example.

### Uses of Fish Feeds

Fish feeds according to the invention may be used to feed a variety of farmed fish, such as salmonids, including, but not limited to, salmon, trout, chars, freshwater whitefishes, and graylings. The exact content of oil and other nutrients may be adjusted to the local growing area as noted above and to the nutritional needs of the specific fish species. Furthermore, it may be possible to design the feeds so that the fish meat will ultimately have a particular EPA+DHA or a particular EPA+DPA+DHA content by adjusting the EPA+DHA or EPA+DPA+DHA content of the fish feed.

The invention will be further described in the following examples, which do not limit the scope of the invention described in the claims.

### EXAMPLES

### Example I

Latitude Oil™ as a sustainable alternative to dietary fish oil in rainbow trout (Oncorhynchus mykiss)

Provided herein is the evaluation the transgenic canola oil containing EPA, DPA and DHA as substitutes for fish oil in rainbow trout feeds reflecting current commercial feed formulation in terms of growth performance and n-3 LC-PUFA composition over a complete production cycle, from fingerling to market weight. There are no reported studies on transgenic canola oil throughout the production cycle in rainbow trout. Feeds were formulated that not only support early growth, but to produce a product that meets the nutritional needs of consumers.

### Materials and Methods

### Experimental Design and Diets

The proximate and fatty acid composition of experimental diets are shown in Table 1 and 2. Three experimental diets were prepared and extruded (Bozeman Fish Technology Center, Bozeman, MT) in various sizes from 2.5 mm to 4.5 mm, and were formulated to be isonitrogenous (49% crude protein), isolipidic (20% crude lipid) and isocaloric (24.2 MJ/kg): a control diet (FO 6.43%, Poultry fat 9.57%) and two experimental diets that replace FO by 50% or 100% with Latitude™ oil. All three diets were formulated to reflect commercial feed formulations for rainbow trout and thus included 20% FM. Poultry fat and Latitude™ oil were provided by Tyson and Cargill, respectively. The three experimental diets were formulated to maintain EPA+DHA content (% of the diet) to be 2.7-3.3. To obtain EPA +DHA content, the following proportion of the oils were used, LO-0 (6.43% FO+9.57% Poultry fat), LO-8 (3.21% FO+4.79% Poultry fat+8% LO) and LO-16 (16% LO).

TABLE 1
Formulation and proximate composition
of the experimental diets (as fed).

| | Diets | | |
|---|---|---|---|
| Ingredients (%) | LO-0 | LO-8 | LO-16 |
| Fish meal, sardine^{a} | 20 | 20 | 20 |
| PBM, feed grade^{a} | 12.5 | 12.5 | 12.5 |
| Soybean meal^{a} | 11.5 | 11.5 | 11.5 |
| Soy protein concentrate^{b} | 5.5 | 5.5 | 5.5 |
| Wheat gluten meal^{a} | 1.5 | 1.5 | 1.5 |
| Corn protein concentrate^{c} | 13.5 | 13.5 | 13.5 |
| Wheat flour^{a} | 16.2 | 16.2 | 16.2 |
| Dicalcium phosphate^{a} | 1.4 | 1.4 | 1.4 |
| Trace mineral mix^{d} | 0.1 | 0.1 | 0.1 |
| Vitamin Premix^{e} | 1.0 | 1.0 | 1.0 |
| Choline chloride (60%)^{a} | 0.6 | 0.6 | 0.6 |
| Stay C (35%) vitamin^{f} | 0.2 | 0.2 | 0.2 |
| Fish oil^{a} | 6.43 | 3.21 | 0.0 |
| Poultry fat^{g} | 9.57 | 4.79 | 0.0 |
| Latitude oil^{h} | 0.00 | 8.00 | 16.0 |
| Nutrients (% as-fed basis) | | | |
| Dry Matter | 98.3 | 98.5 | 97.9 |
| Protein | 50.0 | 49.4 | 49.6 |
| Fat | 20.3 | 21.0 | 20.1 |
| Ash | 3.66 | 3.54 | 3.14 |
| Gross energy (MJ/kg) | 24.3 | 24.4 | 23.9 |

^{a}Rangen Inc., Buhl, ID, USA.
^{b}Profine VF, The Solae Company, St. Louis, MO, USA
^{c}Empyreal ® 75, Cargill Corn Milling, Cargill, Inc., Blair, NE, USA
^{d}US Fish and Wildlife Service Trace Mineral Premix #3. It supplied the following (mg/kg diet): Zn (as ZnSO4•7H2O), 75; Mn (as MnSO4), 20; Cu (as CuSO4•5H2O), 1.54; I (as KIO3), 10.
^{e}Vitamin premix supplied the following per kg diet: vitamin A, 2.4 mg; vitamin D, 0.15 mg; vitamin E, 267 mg; vitamin K as menadione sodium bisulfite, 20 μg; thiamin as thiamin mononitrate, 32 mg; riboflavin, 64 mg; pyridoxine as pyridoxine-HCl, 64 mg; pantothenic acid as Ca-d-pantothenate, 192 mg; niacin as nicotinic acid, 240 mg; biotin, 0.56 mg; folic acid, 12 mg; vitamin B12, 50 μg; and inositol as meso-inositol, 400 mg.
^{f}Skretting USA, Tooele, UT, USA.
^{g}Tyson Foods Inc., Springdale, AR, USA
^{h}Cargill Inc., Minneapolis, MN, USA

TABLE 2
Analyzed fatty acid profile of the experimental diets^{a}

| | Diet | | |
|---|---|---|---|
| | LO-0 | LO-8 | LO-16 |
| Fatty acids | % Diet | % Diet | % Diet |
| C14:0 | 0.39 | 0.25 | 0.08 |
| C16:0 | 3.78 | 2.80 | 1.84 |
| C18:0 | 1.12 | 1.01 | 0.77 |
| C24:0 | 0.39 | 0.25 | 0.08 |
| ΣSFA | 5.68 | 4.31 | 2.76 |
| C16:1n-7 | 1.44 | 0.90 | 0.28 |
| C18:1n-9 | 5.89 | 5.76 | 5.34 |
| C20:1n-9 | 0.48 | 0.36 | 0.19 |
| C22:1n-9 | 0.24 | 0.14 | 0.03 |
| ΣMUFA | 8.04 | 7.17 | 5.84 |
| C18:2n-6 | 3.04 | 4.26 | 5.21 |
| C18:3n-6 | 0.03 | 0.21 | 0.38 |
| C20:2n-6 | 0.03 | 0.02 | 0.02 |
| C20:3n-6 | 0.03 | 0.27 | 0.50 |
| C20:4n-6 (ARA) | 0.24 | 0.40 | 0.53 |
| n-6 PUFA | 3.38 | 5.17 | 6.64 |
| C18:3n-3 | 0.25 | 0.49 | 0.68 |
| C20:5n-3 (EPA) | 1.50 | 2.17 | 2.64 |
| C22:5n-3 (DPA) | 0.19 | 0.35 | 0.46 |
| C22:6n-3 (DHA) | 1.28 | 1.05 | 0.68 |
| EPA + DHA | 2.78 | 3.22 | 3.32 |
| n-3 PUFA | 3.21 | 4.06 | 4.46 |

^{a}Abbreviations: SFA, saturated fatty acids; MUFA, mono-unsaturated fatty acids; n-6 PUFA, n-6 poly-unsaturated fatty acids; n-3 PUFA, n-3 poly-unsaturated fatty acids; ARA, arachidonic acid; EPA, eicosapentaenoic acid; DPA, docosapentaenoic acid; DHA, docosahexaenoic acid.

In vivo digestibility was determined for Latitude™ oil fed to rainbow trout. A reference diet containing practical ingredients and 0.1% yttrium oxide was prepared. A batch of test diet containing 20% test ingredient and 80% reference diet mash (combined on a dry-matter basis) was prepared and analyzed. All ingredients were mixed and cold pelleted at the University of Idaho's Hagerman Fish Culture Experiment Stations (HFCES) using a laboratory-scale California pellet mill fitted with a 4-mm die. After 36 h drying in a hot-air dryer at 37° C., the feeds were stored at ambient temperature (20-22° C.) until fed.

### Experimental Fish and Feeding Trial

Rainbow trout fingerlings, hatched from eggs obtained from Trout Lodge (Sumner, WA). Rainbow trout juveniles (initial body weight: 18.5±0.3 g) were randomly stocked into each of 9, 145-L tanks at 40 fish per tank. Constant temperature spring water (15° C.) was supplied at 8-10 L/min to each experimental tank. Each diet was assigned randomly to three tanks in a completely randomized design. Fish were hand-fed to apparent satiation three times per day, six days per week for 24 weeks. After 24 weeks, all fish were moved to an outdoor facility and stocked into each of 8, 1300-L tanks for another 28 weeks (52 weeks total). Photoperiod indoors (weeks 1-24) was maintained at 14 h light: 10 h dark with fluorescent lights controlled by electric timers. Tank 9 (Diet 2) was removed from the study due to a valve failure resulting in a period of no water overnight followed by poor fish performance and symptoms consistent with bacterial gill disease.

### Sample Collection and Proximate Analysis

At the end of 52 weeks, 24-hour postprandial, three fish per tank were anesthetized with tricaine methanesulfonate (MS-222, 100 mg/L, buffered to pH 7.0). Then, individual body weight and length of fish was measured, and the growth parameters were calculated accordingly. Plasma was collected from the caudal vessels of fish with 1-ml heparinized syringes fitted with a 24G 1.5-inch needle and centrifuged at 1000 g for 10 min to collect plasma for antioxidant enzyme activity and non-specific immune parameters. Liver and viscera were dissected from the fish identified above and were weighed individually to calculate the hepatosomatic index (HSI) and viscerosomatic index. Upon euthanizing those fish with additional MS-222, liver and white muscle were excised for gene expression, fatty acid analysis, and proximate analysis. Liver and distal intestine were excised for histology. Another three fish per tank were sacrificed for whole body proximate analysis. Tissue samples were snap-frozen in liquid nitrogen and stored at −80° C. until analysis.

Experimental feeds, liver, muscle, and whole-body fish samples were analyzed for proximate composition and energy content. Fish samples were pooled by tank and homogenized using an industrial food processor. Samples were dried in a convection oven at 105° C. for 12 h to determine moisture level according to AOAC (2000). Dried samples were finely ground by mortar and pestle and analyzed for CP (total nitrogen x 6.25) using combustion method with a nitrogen determinator (Elementar nitrogen analyzer, Ronkonkoma, NY). Crude lipid was analyzed by subjecting samples to acid hydrolysis using an ANKOM HCL hydrolysis system (ANKOM Technology, Macedon, NY) and extracting them with petroleum ether using an ANKOM XT15 extractor. Ash was analyzed by incineration at 550° C. in a muffle furnace for 5 h. The energy content of samples was determined using an isoperibol bomb calorimeter (Parr 6300, Parr Instrument Company Inc., Moline, IL).

The fatty acid composition of the liver and fillet samples were determined in line with the modified AOAC method 991.39 (24). Briefly, samples were dried for 5-6 h under an N2 stream at 50° C. (OA-SYS heating system, Organomation Associates, Inc., Berlin, MA, USA). Thereafter, 2 mL of 0.5 N NaOH was added for sample saponification at 70° C. for 60 min. Following sample cooling, the free fatty acids were methylated by the addition of 2 mL 14% BF3 (Boron trifluoride) in methanol and incubated at 70° C. for 60 min. After the samples were allowed to cool, 2 mL of hexane was added, inverted repeatedly for 60 s, and 1 mL of saturated NaCl was added. The samples were again inverted repeatedly for 60 s and then centrifuged at 2000×g for 5 min. An aliquot (100 μL) of the clarified hexane extract was diluted in hexane (1:10) and put into autosampler vials for gas chromatography/mass spectroscopy (GC/MS) analysis. The injection mode with a helium flow rate and the column temperature was as described by Overturf et al. (2013). All the analyses were done in duplicate. Fillet results are provided as mg/100 g, assuming a 100 g portion size for human consumption.

### RNA Extraction and Quantitative PCR

Total RNA was isolated from liver and muscle tissue and converted to cDNA following accepted methods. Extracted RNA was treated with DNAse, then 1 μg of total RNA was reverse transcribed using the iScript™ cDNA Synthesis kit (BioRad, Hercules, CA). Real-time quantitative PCR was carried out on a CFX96 Real-Time System (BioRad) in a 10 μL total volume reaction using iTaq SYBR Green Supermix (BioRad) and 300 and 500 nmol primers according to the protocol provided by the manufacturer. PCR cycling conditions for all genes were as follows: 95° C. for 5 s followed by 55° C. for 30 s over 40 cycles with an initial denaturation step of 95° C. for 3 min. For each fish, PCR reactions were run in duplicate on RNA samples. Extracted RNA was quantified and treated with DNAse, and 1 μg were the reverse-transcribed following the methods of the manufacturer (BioRad, Hercules, CA). Relative expression values for genes constituting the fatty acid oxidation, desaturation and elongation, including delta-5 fatty acyl desaturase (d5fad), delta-6 fatty acyl desaturase (d6fad), fatty acid elongase 2 (elovl2), fatty acid elongase 5 (elovl5) and acyl-Coa oxidase were determined using primers designed from rainbow trout sequences in the NCBI Genbank® database. In addition, a cellular mRNA control was selected from a set of two reference genes (Arp). Primer PCR efficiency was calculated by including six serial dilutions of a standard (pooled from each experimental sample for a given tissue) and utilized for PCR correction for all primer pairs (Pfaffl, 2001). Primer sequences for genes are given in Table 3. Normalized data were analyzed using the relative quantification method described by Pfaffl (2001).

TABLE 3
Primers sequences used in real-time qPCR for
the determination of gene expression.

| | | | | Gene |
|---|---|---|---|---|
| Genes | Forward | Reverse | Bases | Accession NO |
| Elovl-2 | GATGCCTGCTCTTCCAGTTC | CATTGGTGGAGACAGTGTGG | 20 | KM244737 |
| | (SEQ ID NO: 1) | (SEQ ID NO: 2) | | |
| Elovl-5 | CTATGGGCTCTC TGCTGTCC | TATCGTCTGGGA CATGGTCA | 20 | AY605100 |
| | (SEQ ID NO: 3) | (SEQ ID NO: 4) | | |
| Δ5 fad | GCAGAGAGAACCGAGGATGG | GCAGTGCTTCTG GACCTCTT | 20 | JD087459 |
| | (SEQ ID NO: 5) | (SEQ ID NO: 6) | | |
| Δ6 fad | ACCTAGTGGCTCCTCTGGTC | CAGATCCCCTGACTTCTTCA | 20 | AF301910 |
| | (SEQ ID NO: 7) | (SEQ ID NO: 8) | | |
| ACOX | TTCCACGACCAGACCCATGA | AACGGCGTCCACCAAAGCTA | 20 | BX085367 |
| | (SEQ ID NO: 9) | (SEQ ID NO: 10) | | |
| Arp | GAAGGCTGTGGTGCTCAT | CAGGGCAGGGTTCTC | 18 | XM_021610240.2 |
| | (SEQ ID NO: 11) | (SEQ ID NO: 12) | | |

### Calculation and Statistical Method

Using the live-weight and feed consumption data, the following indices were calculated.

Weight gain (WG, g/fish)=(g mean final weight-g mean initial weight)

Specific growth rate (SGR, %/d)=[(Ln mean final weight−Ln mean initial weight)/number of days]×100

Survival (%)=(number of fish at the end of the trial/number of fish at the beginning)×100

Average feed intake (FI, g/fish)=g total dry feed intake/number of surviving fish

Feed conversion ratio (FCR)=g total feed consumed/(g final biomass−g initial biomass+g dead fish weight)

Condition factor (CF)=(g body weight)/(cm body length)3×100

Hepatosomatic index (HSI)=(g liver weight)/(g whole body weight)×100

Viscerosomatic index (VSI)=(g visceral weight)/(g whole body weight)×100

ADC diet=1−[(F/D)×(Di/Fi)]—where D=% lipid of diet, F=% lipid of feces, Di=% digestion indicator of diet, Fi=% digestion indicator of feces

ADC ingredient=ADCT+[((1−s) DR)/s DI]×(ADCT−ADCR)

where ADCT=ADC of test diet, ADCR=ADC of reference diet, DR=% lipid of reference diet,
DI=% lipid of test ingredient, s=proportion of test ingredient in test diet (0.2)

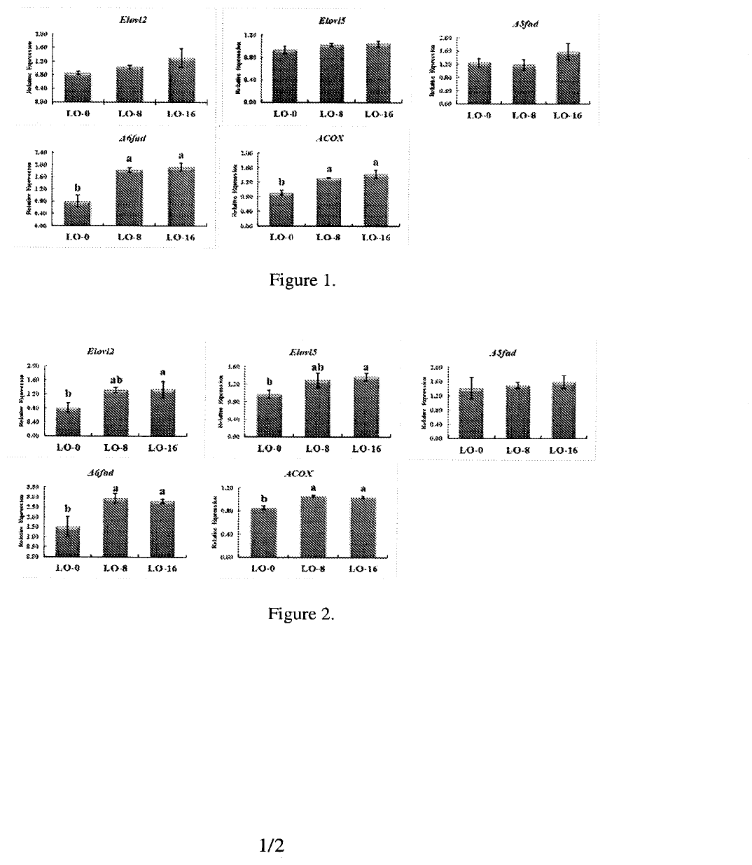

Tank mean values (n=3 except diet 2; n=2) were used for statistical analysis. Fish growth and feed utilization indices, physiological parameters, and gene expression data were tested for normality and homogeneity of variance prior to one-way Analysis of Variance (ANOVA). If significant differences were found, data were subjected to Tukey's HSD test to separate the means at a significance level of P<0.05. IBM SPSS (Version 21 for Window; IBM SPSS Inc., Chicago, IL, USA) was used for all statistical analyses. A principal component analysis (PCA) was performed to analyze the non-specific immune response parameters (FIG. 1 (A)) the fatty acid composition of the fillet (FIG. 1 (B)) and with the software R Statistics version 4.0.2 (The R Foundation, Vienna, Austria). As histological results were not normally distributed, histological results were analyzed using the Kruscal-Wallis test followed by Wilcoxon post-hoc analysis.

### Results

### Growth Performance and Feed Utilization

The growth performance and feed utilization of the fish are presented in Table 4. The final weight, weight gain, and SGR of fish fed diet LO-8 or LO-16 were the greatest (P<0.05) compared with the fish fed LO-0. The survival rate (74.8%-83.8%) and feed conversion ratio (1.27-1.32) were similar among dietary treatments groups (P>0.05). Results also showed that CF, HSI and VSI were not significantly affected by dietary treatments (P>0.05). ADC for crude lipid of Latitude™ oil was 93%=0.2.

TABLE 4
Growth performance and feed utilization
of rainbow trout fed for 52 weeks*.

| | Diets | | |
|---|---|---|---|
| | LO-0 | LO-8 | LO-16 |
| Initial weight (g) | 18.5 ± 0.09 | 18.5 ± 0.08 | 18.5 ± 0.08 |
| Final weight (g) | 869 ± 18.6^{b} | 967 ± 36.4^{a} | 955 ± 10.8^{a} |
| Weight gain (g/fish) | 850 ± 18.5^{b} | 949 ± 36.4^{a} | 937 ± 10.8^{a} |
| SGR¹ | 1.07 ± 0.10^{b} | 1.10 ± 0.01^{a} | 1.10 ± 0.00^{a} |
| Feed intake (g/fish) | 1076 ± 12.1 | 1219 ± 65.5 | 1244 ± 73.5 |
| FCR² | 1.27 ± 0.04 | 1.28 ± 0.02 | 1.32 ± 0.07 |
| Survival rate (%) | 83.8 ± 2.21 | 83.8 ± 2.70 | 74.8 ± 4.59 |
| Condition factor (%) | 1.19 ± 0.08 | 1.22 ± 0.06 | 1.22 ± 0.03 |
| HSI³ | 0.84 ± 0.07 | 0.88 ± 0.00 | 0.74 ± 0.05 |
| VSI⁴ | 9.07 ± 0.78 | 8.90 ± 0.27 | 9.09 ± 0.90 |

^{a} and ^{b}Mean ± SE (n = 3) except for diet 2 (n = 2) in the same row that share the same superscript are not statistically different (ANOVA, P > 0.05)
¹SGR: specific growth rate (%/day)
²FCR: feed conversion ratio
³HSI: hepatosomatic index (%)
⁴VSI: viscerosomatic index (%)

### Whole-Body, Liver and Fillet Proximate Composition

Whole-body, liver and fillet proximate composition of rainbow trout juveniles fed the experimental diets are presented in Table 5. Dry matter of fish whole-body, liver and fillet ranged from 28.8% to 33.3%, 13.2% to 15.2%, and 20.3% to 21.6%, with the LO-16 treatment consistently lower. There were no consistent dietary effects for percent crude protein, crude fat of gross energy across tissues. Statistically, there were no differences in whole-body, liver, and fillet proximate composition and gross energy among the treatment groups

TABLE 5
Whole-body, liver and fillet proximate composition and gross energy
(wet basis) of rainbow trout fed experimental diets for 52 weeks*.

| | Diets | | |
|---|---|---|---|
| | LO-0 | LO-8 | LO-16 |
| Whole-body | | | |
| Dry matter (%) | 29.3 ± 3.15 | 33.3 ± 0.68 | 28.8 ± 1.06 |
| Crude protein (%) | 17.5 ± 1.09 | 18.2 ± 0.58 | 18.0 ± 0.64 |
| Crude fat (%) | 9.40 ± 2.45 | 12.8 ± 1.28 | 8.80 ± 1.45 |
| Ash (%) | 2.1 ± 0.31 | 1.7 ± 0.34 | 2.3 ± 0.26 |
| Gross energy (MJ/kg) | 26.8 ± 0.84 | 28.2 ± 0.84 | 26.7 ± 0.78 |
| Liver | | | |
| Dry matter (%) | 14.7 ± 1.05 | 15.2 ± 0.93 | 13.2 ± 0.75 |
| Crude protein (%) | 9.63 ± 0.27 | 9.67 ± 0.63 | 8.81 ± 0.52 |
| Crude fat (%) | 0.83 ± 0.21 | 0.64 ± 0.12 | 0.47 ± 0.02 |
| Gross energy (MJ/kg) | 22.0 ± 0.17 | 22.1 ± 0.03 | 22.0 ± 0.07 |
| Fillet | | | |
| Dry matter (%) | 21.6 ± 0.67 | 20.3 ± 0.04 | 21.3 ± 1.16 |
| Crude protein (%) | 16.0 ± 0.81 | 14.8 ± 0.18 | 15.7 ± 0.47 |
| Crude fat (%) | 4.95 ± 0.12 | 4.48 ± 0.28 | 5.00 ± 0.41 |
| Gross energy (MJ/kg) | 26.2 ± 0.13 | 25.8 ± 0.26 | 26.0 ± 0.19 |

Mean ± SE (n = 3) except for diet 2 (n = 2) in the same row are not statistically different (ANOVA, P > 0.05)

### Fatty Acid Composition of Fillet

Fillet fatty acid composition of rainbow trout juveniles fed the experimental diets are presented in Table 6. Linoleic acid (C18:2n-6) of fish fillet of fish fed diet LO-16 (795 mg/100 g) was significantly higher than those of fish fed diet LO-8 (648 mg/100g) (P<0.05). α-linolenic acid (C18:3n-3), arachidonic acid (C20:4n-6), EPA and docosapentaenoic acid (C22:5n-3) content was significantly higher in LO-16 diet group compared to other groups (P<0.05). The fillet DHA (C22:6n-3) content of fish fed diet LO-8 was numerically higher than those of fish fed other two diets (P>0.05). EPA+DHA contents were numerically increased as Latitude™ oil inclusion level increased to 8% and 16%, but not statistically different (P>0.05).

TABLE 6
Fillet fatty acid composition of rainbow trout juveniles.

| Fatty acids | Diet | | |
|---|---|---|---|
| (mg/100 g) | LO-0 | LO-8 | LO-16 |
| C14:0 | 60.3 ± 2.17 | 46.1 ± 13.0 | 43.8 ± 4.79 |
| C16:0 | 845 ± 50.2^{a} | 665 ± 22.6^{b} | 668 ± 60.3^{ab} |
| C18:0 | 235 ± 18.7 | 185 ± 7.21 | 211 ± 11.2 |
| C24:0 | 59.7 ± 2.97 | 46.1 ± 13.0 | 47.6 ± 7.27 |
| ΣSFA | 1200 ± 36.3^{a} | 942 ± 10.6^{b} | 970 ± 62.2^{b} |
| C16:1-7 | 246 ± 23.6^{a} | 208 ± 9.04^{ab} | 179 ± 18.5^{b} |
| C18:1n-9 | 1297 ± 40.5^{a} | 1079 ± 31.5^{b} | 1272 ± 38.2^{a} |
| C20:1n-9 | 92.5 ± 12.6^{a} | 49.1 ± 12.7^{b} | 68.1 ± 3.92^{ab} |
| C22:1n-9 | 24.3 ± 5.20^{a} | 13.5 ± 2.07^{ab} | 8.55 ± 0.29^{b} |
| ΣMUFA | 1660 ± 81.6^{a} | 1350 ± 55.3^{b} | 1528 ± 54.7^{ab} |
| C18:2n-6 | 710 ± 26.0^{ab} | 648 ± 17.6^{b} | 795 ± 27.1^{a} |
| C18:3n-6 | 6.57 ± 1.46^{b} | 12.3 ± 0.27^{b} | 26.6 ± 3.78^{a} |
| C20:3n-6 | 21.5 ± 2.80^{b} | 41.0 ± 2.11^{b} | 81.4 ± 17.6^{a} |
| C20:4n-6 (ARA) | 51.9 ± 7.11^{b} | 66.8 ± 2.87^{b} | 93.3 ± 8.32^{a} |
| n-6 PUFA | 823 ± 40.3^{b} | 789 ± 18.1^{b} | 1027 ± 61.1^{a} |
| C18:3n-3 | 41.0 ± 5.09^{b} | 50.2 ± 1.36^{b} | 78.5 ± 8.74^{a} |
| C20:5n-3 (EPA) | 239 ± 4.95^{b} | 241 ± 7.24^{b} | 416 ± 14.6^{a} |
| C22:5n-3 (DPA) | 71.3 ± 3.00^{b} | 70.3 ± 3.30^{b} | 133 ± 9.78^{a} |
| C22:6n-3 (DHA) | 840 ± 68.8 | 934 ± 16.3 | 825 ± 49.2 |
| EPA + DHA | 1079 ± 63.9 | 1175 ± 23.6 | 1241 ± 62.5 |
| n-3 PUFA | 1191 ± 56.3^{b} | 1296 ± 21.6^{ab} | 1453 ± 69.5^{a} |

*Values are mean ± SE (n = 3) except for diet 2 (n = 2) in the same row that share the same superscript or absence of superscripts are not statistically different (ANOVA, P > 0.05).

### Gene Expression

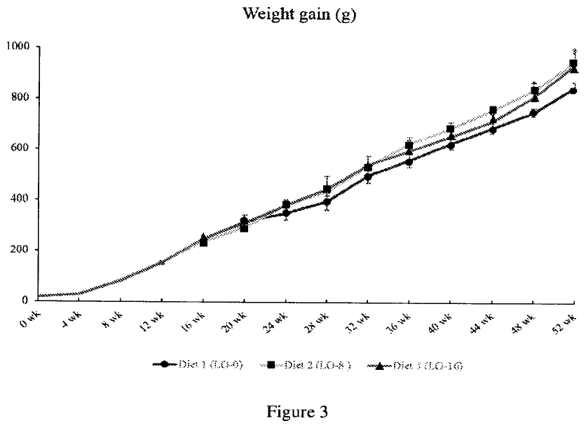

The relative mRNA (RT-qPCR) expression of fatty acid metabolism related genes, fatty acid elongases 2 and 5 (Elovl-2 and Elovl-5), fatty acid desaturases (Afad and Δ6fad) and acyl-CoA oxidase (ACOX) in liver and muscle of rainbow trout fed experimental diets is presented in FIGS. 2 and 3. The hepatic gene expression of Elovl-2 and Elovl-5 were unaffected by the diet (P>0.05) (FIG. 1), however those genes were significantly upregulated (P<0.05) in the LO-16 group compared to LO-(group in muscle. The fish fed LO-8 or LO-16 diet showed a significantly higher expression of Δ6fad as well as ACOX in both liver and muscle compared to the fish fed LO-0) diet, while the relative mRNA expression of Δ5fad was not significantly different among the dietary treatment group (P>0.05).

### Discussion

This study is the first to address the impact of the substitution of terrestrial oils (FO and poultry fat) by transgenic canola oil, up to 100% substitution, on rainbow trout performance, health, and n-3 LC-PUFA tissue composition over a complete production cycle, from fingerling to the marketing size (52 weeks). In the present study, while formulating diets, EPA+DHA contents (% of the diet) were maintained to be in the range between 2.7 and 3.3. Results demonstrate that both inclusion levels of LO (8% and 16%) proved to be effective. Remarkably, the fish fed diet LO-8 and LO-16 showed significantly increased growth performance and fillet EPA+DHA concentrations similar to those achieved in fish fed diet LO-0). While unexpected, the growth results suggest improved lipid utilization in fish fed the diets containing LO compared to fish in the LO-0 diet group. It is worth noting that the growth rates became significantly different after 48 weeks (FIG. 4).

An aspect of the present study was to assess if LO influenced fatty acid metabolism, as it contains high EPA and DPA levels compared to FO. In the present study, muscle fatty acid profiles generally reflected those of the diets, as commonly reported previously in other fish studies. However, interestingly, muscle of fish fed LO-8 diet showed lower levels of fatty acids such as 16:0, 18:1n-9, 18:2n-6 (linoleic acid, LA) and DPA and higher levels of DHA compared to the diet, indicating that the decrease and low retention of these fatty acids were utilized as an energy source by the B-oxidation pathway DPA being converted to DHA. Despite the highest level of DPA in diet LO-16, the concentrations of DHA in the fillet of fish fed diet LO-16 showed numerically lower than those of fish fed diet LO-8, with perhaps the high inclusion of ARA negatively affected the conversion of EPA or DPA to DHA, as ARA, EPA and DPA compete for the same enzymes (elovl2 and 5) in their synthesis pathways. This is supported by relatively higher retention of EPA and DHA in the fillet of fish fed diet LO-16. However, it is worth noting that the fillet DHA content of fish fed diet LO-16 was not significantly different compared to the diet LO-0. In the current study, the fillet EPA+DHA contents of fish fed all three experimental diets satisfied the suggested recommendation by American Heart Association for people without the disease (500 mg/day), with coronary heart disease (1000 mg/day).

The same patterns in gene expression were observed in the liver and fillet. It is generally accepted that the expression of dofad is highly responsive to dietary levels of n-3 LC-PUFA, being up-regulated when fish fed low dietary levels of n-3 LC-PUFA, which leads to increased production of EPA and DHA. In contrast, in the present study, fish fed the diets with either 8% LO or 16% LO showed up-regulation of dofad in liver and fillet, which may be associated with higher levels of DPA included in both diets compared to diet LO-0. The rate-limiting step for the LC-PUFA biosynthetic pathway in fish is controlled by dofad as it is the first enzyme involved in the bioconversion of C18 PUFA to longer and more unsaturated fatty acids and DPA to DHA. This result suggests that the expression of dofad is more affected by the dietary levels of DPA and DHA. Fish fed the LO-16 diet, which had higher EPA and DPA contents than the other two diets, showed up-regulation of Elovl2 and Elovl5 in the fillet, reflecting the higher level of DHA in fillet compared to diet. ACOX is regarded as the rate-limiting enzyme for peroxisomal β-oxidation. In the present study, the expression levels of ACOX were up-regulated in both liver and fillet with increasing levels of dietary DPA, indicating that there was active catabolismof tetracosahexaenoic acid (24:6n-3), the ultimate precursor of DHA. The up-regulated expression of ACOX by LO agrees with the DHA content in the fillet, which may indicate that a higher level of DHA was required by rainbow trout to sustain physiological function.

In conclusion, results of the present study demonstrate that Latitude™M oil is highly digestible, improves fish growth, and yields elevated fillet n-3 LC-PUFA content, making it a sustainable, candidate lipid source for use in trout feeds.

### Example II

### Materials and Methods

### Experimental Design and Diets

Diets were formulated to contain 50% protein, 16% lipid and 24 MJ/kg energy, and meet or exceed the published minimum nutrient requirements for rainbow trout (NRC, 2011). Three experimental feeds for rainbow trout were produced as shown in Table 7. The treatments targeted 2.0, 2.0 and 2.4% total EPA+DHA, respectively, and included a Control diet with a fish oil-poultry oil blend (FPO_2.0), a Latitude™ oil-poultry oil blend diet (LPO_2.0) and a high Latitude™ oil diet (LO_2.4). Experimental diets were produced by cooking extrusion at the Bozeman Fish Technology Center, Bozeman, MT. Pellets were dried to <10% moisture in a forced-air dryer at room temperature. Diets were placed in sealed plastic buckets and stored at room temperature until fed.

Experimental diets: 3 experimental diets were formulated as follows (Table 7):
Diet 1 (FPO_2.0): 0% inclusion of Latitude™ oil
Diet 2 (LPO_2.0): 16% inclusion of Latitude™ oil
Diet 3 (LPO_2.4): 19.3% inclusion of Latitude™ oil

TABLE 7
Formulated ingredient and nutrient composition of experimental diets
for the growth trial with juvenile rainbow trout (%, as-fed basis).

| | Diet 1 | Diet 2 | Diet 3 |
|---|---|---|---|
| INGREDIENTS | FPO_2.0 | LPO_2.0 | LO_2.4 |
| Fish meal, whitefish | 20 | 20 | 20 |
| PBM, feed grade | 8 | 8 | 8 |
| Soy meal, sol ext, Rang | 11 | 11 | 11 |
| Soy protein concentrate | 6 | 6 | 6 |
| Wheat gluten meal | 7.15 | 7.15 | 7.15 |
| Corn protein conc, 75% CP | 12.5 | 12.5 | 12.5 |
| Wheat flour | 12.7 | 12.3 | 12.8 |
| Monocalcium phosphate | 1.4 | 1.4 | 1.4 |
| Trace mineral mix, Trouw | 0.1 | 0.1 | 0.1 |
| Vitamin Premix, ARS 702 | 1 | 1 | 1 |
| Choline chloride | 0.6 | 0.6 | 0.6 |
| Stable C (35%) vitamin | 0.2 | 0.2 | 0.2 |
| Fish oil | 7.84 | 0.00 | 0.0 |
| Poultry fat | 11.53 | 3.26 | 0.0 |
| Omega-3 canola oil | 0.0 | 16.0 | 19.3 |
| Total | 100 | 100 | 100 |
| Nutrients (% as-fed basis) | | | |
| Dry matter | 94.3 | 93.4 | 93.2 |
| Protein | 50.1 | 51.0 | 50.6 |
| Fat | 18.7 | 15.5 | 16.5 |
| Ash | 4.66 | 4.54 | 4.52 |
| Gross energy (MJ/kg) | 23.5 | 23.2 | 23.0 |
| ARA (%) | 0.12 | 0.25 | 0.30 |
| EPA + DHA (%) | 1.47 | 1.26 | 1.60 |

### Experimental Fish and Feeding Trial

Rainbow trout (initial body weight: 16.8±0.1g) of a commercial strain were stocked into each of 12, 145-L tanks at 40 fish per tank supplied with spring water. Each tank was supplied with 8-10 L/min of constant temperature (15° C.) spring water fed by gravity to the fish rearing laboratory. Each diet was assigned randomly to three tanks in a completely randomized design. Fish were hand-fed to apparent satiation three times per day, six days per week for 24 weeks. As fish densities increased, fish were moved to an outdoor facility and stocked into each of 12, 1300-L tanks until ending the study at 47 weeks. Photoperiod indoors was maintained at 14 h light: 10 h dark with fluorescent lights controlled by electric timers.

### Sample Collection and Proximate Analysis

At the end of 47 weeks, 24-hour postprandial, three fish per tank were anesthetized with tricaine methanesulfonate (MS-222, 100 mg/L, buffered to pH 7.0). Plasma was collected from the caudal vessels of fish with 1-ml heparinized syringes fitted with a 24G 1.5-inch needle for ALT and AST determination. Upon euthanizing those fish with additional MS-222, liver and distal intestine were excised for histology. Another three fish per tank were sacrificed for whole body proximate analysis. The remaining fish were filleted, vacuum sealed and frozen for future sensory analysis.

Experimental feeds and whole-body fish samples were analyzed for proximate composition and energy content. Fish samples were pooled by tank and homogenized using an industrial food processor. Samples were dried in a convection oven at 105° C. for 12 h to determine moisture level according to AOAC (2000). Dried samples were finely ground by mortar and pestle and analyzed for CP (total nitrogen×6.25) using combustion method with a nitrogen determinator (Elementar nitrogen analyzer, Ronkonkoma, NY). Crude lipid was analyzed by subjecting samples to acid hydrolysis using an ANKOM HCL hydrolysis system (ANKOM Technology, Macedon, NY) and extracting them with petroleum ether using an ANKOM XT15 extractor. Ash was analyzed by incineration at 550° C. in a muffle furnace for 5 h. The energy content of samples was determined using an isoperibol bomb calorimeter (Parr 6300, Parr Instrument Company Inc., Moline, IL).

### Calculation and Statistical Method

Data calculations and statistics were prepared according to the method described in Example I.

### Results

### Growth Performance and Feed Utilization

Experimental diets were formulated to be isoproteinous, isolipidic and isocaloric, and differ for their fatty acid content (Tables 7 and 8). The experimental diets were formulated to contain EPA+DHA content from 2% (FPO_2.0 and LPO_2.0) to 2.4% (LO_2.4). The analysis value of EPA+DHA in the experimental diets ranged from 1.26% (LPO_2.0) to 1.60% (LO_2.4) of the diet.

TABLE 8
Fatty acid composition of the experimental diets as both a percentage
of total fatty acid methyl esters (FAME) and % of the diet.

| | Diet | | | | | |
|---|---|---|---|---|---|---|
| | FPO_2.0 | | LPO_2.0 | | LO_2.4 | |
| | % | % | % | % | % | % |
| Fatty acids | FAME | Diet | FAME | Diet | FAME | Diet |
| C14:0 | 0.13 | 0.02 | 0.05 | 0.01 | 0.01 | 0.00 |
| C16:0 | 22.9 | 4.28 | 11.5 | 1.79 | 7.86 | 1.30 |
| C16:1 | 6.23 | 1.17 | 2.13 | 0.33 | 0.85 | 0.14 |
| C18:0 (SA) | 5.44 | 1.02 | 4.15 | 0.64 | 3.54 | 0.58 |
| C18:1n-9 (OA) | 32.1 | 6.00 | 32.8 | 5.08 | 32.5 | 5.36 |
| C18:2n-6 (LA) | 15.1 | 2.83 | 25.2 | 3.91 | 26.9 | 4.45 |
| C18:3n-3 (ALA) | 1.06 | 0.20 | 2.16 | 0.33 | 2.41 | 0.40 |
| C20:4n-6 (ARA) | 0.63 | 0.12 | 1.59 | 0.25 | 1.83 | 0.30 |
| C20:5n-3 (EPA) | 4.68 | 0.87 | 6.94 | 1.08 | 8.39 | 1.39 |
| C22:5n-3 (DPA) | 0.74 | 0.14 | 1.44 | 0.22 | 1.75 | 0.29 |
| C22:6n-3 (DHA) | 3.17 | 0.59 | 1.36 | 0.21 | 1.29 | 0.21 |
| EPA + DHA | 7.84 | 1.47 | 8.30 | 1.29 | 9.69 | 1.60 |

The growth performance and feed utilization of the fish are presented in Table 9. The final weight, weight gain, SGR, and feed intake of fish fed Diet 2 (LPO_2.0) and Diet 3 (LPO_2.4) were higher (P<0.05) compared with the fish fed the FPO_2.0 diet. Percent survivals and feed conversion ratios were similar among dietary treatments groups (P>0.05). Results also showed that CF, length, VFI and FI were not significantly affected by dietary treatment (P<0.05). However, HSI was significantly higher in FPO_2.0 diet group compared to fish in the LPO_2.4 group.

TABLE 9
Growth performance and feed utilization of rainbow trout for 47 weeks¹.

| | Diet | | | |
|---|---|---|---|---|
| | FPO_2.0 | LPO_2.0 | LO_2.4 | P-value |
| Initial weight (g) | 17.0 ± 0.17 | 16.7 ± 0.06 | 16.6 ± 0.04 | 0.180 |
| Final weight (g) | 1129 ± 24.6^{b} | 1233 ± 16.0^{a} | 1232 ± 13.2^{a} | 0.011 |
| Weight gain | 1112 ± 24.7^{b} | 1216 ± 15.9^{a} | 1215 ± 13.2^{a} | 0.011 |
| (g/fish) | | | | |
| SGR (%/day)² | 1.28 ± 0.02^{b} | 1.31 ± 0.00^{a} | 1.31 ± 0.00^{a} | 0.005 |
| Feed intake | 1367 ± 39.8^{b} | 1545 ± 23.6^{a} | 1575 ± 33.8^{a} | 0.008 |
| (g/fish) | | | | |
| FCR³ | 1.23 ± 0.01 | 1.27 ± 0.02 | 1.30 ± 0.02 | 0.137 |
| Survival rate (%) | 75.0 ± 2.95 | 84.7 ± 2.30 | 77.8 ± 2.78 | 0.126 |
| Condition factor | 1.48 ± 0.01 | 1.54 ± 0.03 | 1.59 ± 0.03 | 0.084 |
| (%) | | | | |
| Length (cm) | 41.4 ± 0.50 | 42.5 ± 0.32 | 42.2 ± 0.37 | 0.220 |
| HSI (%)⁴ | 0.78 ± 0.00^{a} | 0.63 ± 0.02^{b} | 0.70 ± 0.02^{ab} | 0.003 |
| VFI (%)⁵ | 2.61 ± 0.49 | 2.68 ± 0.27 | 2.90 ± 0.30 | 0.814 |
| FY (%)⁶ | 59.0 ± 1.00 | 58.4 ± 1.47 | 59.8 ± 1.07 | 0.693 |

¹Mean ± SE (n = 4) in the same row that share the same superscript are not statistically different (P > 0.05; Completely Randomized Design, One-way ANOVA; Tukey's HSD test).
²Specific growth rate
³Feed conversion ratio
⁴Hepatosomatic index
⁵Visceral fat index
⁶Fillet yield

### Whole-Body, Liver and Fillet Proximate Composition

Whole-body and fillet proximate composition of rainbow trout fed the experimental diets are presented in Table 10. Decreased gross energy was detected in the fillet of fish fed LPO_2.0 and LPO_2.4 diets (P<0.05). No consistent dietary effect was observed except for fillet gross energy.

TABLE 10
Whole-body and fillet proximate composition (%, wet basis)
of rainbow trout fed experimental diets for 47 weeks¹.

| Proximate | Diet | | | |
|---|---|---|---|---|
| Composition | FPO_2.0 | LPO_2.0 | LO_2.4 | P-value |
| Whole-body | | | | |
| Dry matter (%) | 34.3 ± 0.73 | 35.1 ± 0.59 | 34.2 ± 1.03 | 0.708 |
| Crude protein (%) | 17.7 ± 0.15 | 18.0 ± 0.43 | 17.0 ± 0.26 | 0.131 |
| Crude fat (%) | 14.4 ± 0.69 | 14.6 ± 0.56 | 14.9 ± 0.87 | 0.908 |
| Ash (%) | 2.05 ± 0.10 | 2.04 ± 0.07 | 1.85 ± 0.18 | 0.501 |
| Gross energy (MJ/kg) | 28.3 ± 0.41 | 28.4 ± 0.16 | 28.5 ± 0.25 | 0.828 |
| Fillet | | | | |
| Dry Matter (%) | 25.5 ± 0.90 | 23.6 ± 1.02 | 23.6 ± 2.19 | 0.228 |
| Crude Protein (%) | 20.7 ± 0.56 | 20.0 ± 0.82 | 19.9 ± 1.78 | 0.284 |
| Crude Fat (%) | 3.07 ± 0.58 | 2.34 ± 0.46 | 2.57 ± 0.61 | 0.364 |
| Ash (%) | 1.94 ± 0.20 | 1.60 ± 0.10 | 2.11 ± 0.03 | 0.284 |
| Gross energy (MJ · kg) | 22.8 ± 0.22^{a} | 21.7 ± 0.23^{b} | 22.1 ± 0.33^{b} | 0.003 |

¹Mean ± SE (whole body n = 4 except for Diet 1 n = 3, fillet n = 4 except for diet 2 n = 3) in the same row that share the same superscript are not statistically different (P > 0.05; Completely Randomized Design, One-way ANOVA; Tukey's HSD test).

### Plasma Alanine Transaminase, Aspartate Aminotransferase Activity, and Histological Analysis

Results of plasma ALT and AST activities are shown in Table 11. The plasma of fish fed FPO_2.0 diet showed significantly higher level of ALT activity compared to fish fed LO_2.4 diet (P<0.05). AST activity was not significantly influenced by dietary treatments (P>0.05).

TABLE 11
Plasma alanine transaminase and aspartate aminotransferase
following different dietary treatments fed for 47 weeks¹.

| | Diet | | | |
|---|---|---|---|---|
| Plasma | FPO_2.0 | LPO_2.0 | LO_2.4 | P-value |
| ALT (U/L)² | 3.41 ± 0.46^{a} | 2.42 ± 0.25^{ab} | 2.08 ± 0.17^{b} | 0.029 |
| AST (U/L)³ | 2.7 ± 0.02 | 2.68 ± 0.01 | 2.67 ± 0.01 | 0.160 |

¹Mean ± SE (n = 12 fish per treatment) in the same row that share the same superscript are not statistically different (P > 0.05; Completely Randomized Design, One-way ANOVA; Tukey's HSD test).
²Alanine transaminase
³Aspartate aminotransferase

Higher dietary inclusion of Latitude™ oil in trout feeds and specifically, the effects on trout growth, survival, and health over a complete production cycle, from fingerling to market weight. Both inclusion levels of LO (16% and 19.3%) proved to be effective, yielding growth rates higher than fish fed the control diet (FO_2.0). These results are consistent with findings in Example I that trout fed diets containing 8 and 16% LO, respectively, grew faster than fish fed a fish oil diet when grown over a complete market cycle. Furthermore, inclusion of LO resulted in improved fish health compared to fish in the control group, demonstrated by decreased level of ALT and HSI. Plasma AST and ALT are often used for the evaluation of the liver function as they are released into the blood during injury or damage to the liver cells. LO did not influence the structural morphology in distal intestine or liver.

In summary, the present results demonstrate that Latitude™M oil improved fish growth and health and served as a lipid source for use in trout feeds.

### BIBLIOGRAPHY

1. AOAC (Association of Official Analytical Chemists) (2000) In: Cunniff, P. (Ed.), Official Methods of Analysis of the Association of Official Analytical Chemists, 17th edition. Association of Official Analytical Chemists, Inc., Arlington, VA Chapter 4. P 46.
2. NRC (National Research Council), 2011. Nutrient Requirements of Fish and Shrimp. National Academy Press, Washington, DC, p. 376.
3. Overturf, K., Welker, T., Barrows, F., Towner, R., Schneider, R., LaPatra, S. (2013). Variation in rainbow trout, Oncorhynchus mykiss, to biosynthesize eicosapentaenoic acid and docosahexaenoic acid when reared on plant oil replacement feeds. J. World Aquacult. Soc. 44, 326-337
4. Pfaffl, M. W. (2001). A new mathematical model for relative quantification in real-time RT-PCR. iNucleic acids research, 29 (9), e45.

The invention is described with reference to various embodiments and techniques. However, it should be understood that many variations and modifications may be made while remaining within its scope. All referenced publications, patents and patent documents, as well as accession number for DNA, RNA and protein sequences, are intended to be incorporated by reference, as though individually incorporated by reference.

1. A method to increase weight gain in farmed fish comprising providing a feed composition to said fish, wherein said feed composition comprises 6% to 40% w/w of an oil derived from a genetically modified oilseed crop plant, wherein the oil from the genetically modified oilseed crop plant comprises at least 10% to 40% EPA, DHA and DPA.

2. The method of claim 1, wherein the weight gain is increased by 10-20% as compared to control farmed fish not fed the feed composition comprising oil from the genetically modified oilseed crop plant.

3. A method to provide a higher final weight of farmed fish comprising providing a feed composition to said fish, wherein said feed composition comprises 6% to 40% w/w of an oil derived from a genetically modified oilseed crop plant, wherein the oil from the genetically modified oilseed crop plant comprises at least 10% to 40% EPA, DHA and DPA.

4. The method of claim 3, wherein the final weight is increased by at least 9.5% to 22% as compared to control fish not fed the feed composition comprising oil from the genetically modified oilseed crop plant.

5. A method to increase specific growth rate (SGR) of farmed fish comprising providing a feed composition to said fish, wherein said feed composition comprises 6% to 40% w/w of an oil derived from a genetically modified oilseed crop plant, wherein the oil from the genetically modified oilseed crop plant comprises at least 10% to 40% EPA, DHA and DPA.

6. The method of claim 5, wherein the SGR is increased by at least 2-4%, including 2.8%, as compared to control fish not fed the feed composition comprising oil from the genetically modified oilseed crop plant.

7. A method to provide DHA to farmed fish fillets comprising providing a feed composition to said fish, wherein said feed composition comprises 6% to 40% w/w of an oil derived from a genetically modified oilseed crop plant, wherein the oil from the genetically modified oilseed crop plant comprises at least 10% to 40% EPA, DHA and DPA, wherein said EPA and DPA from said plant oil is converted to DHA that is deposited in said fillets of said fish.

8. The method of claim 1, wherein the added oil in the feed composition comprises up to 50% added oil from plant oil.

9. The method of claim 1, wherein the added oil in the feed composition is 100% added oil from plant oil.

10. The method of claim 1, wherein the oil from the genetically modified oilseed crop plant comprises at least 38.6% EPA, DHA and DPA.

11. The method of claim 1, wherein the oil from the genetically modified oilseed crop plant comprises at least 12.9% EPA, DHA and DPA.

12. The method of claim 1, wherein the feed composition is provided to said fish from first feeding to harvest.

13. The method of claim 1, wherein the feed composition is provided to said fish for 6 to 36 months, including 12 months.

14. The method of claim 1, wherein the feed composition is provided to said fish at starting weight of from about 10-30 g to a finishing weight about 800-1200 g.

15. The method of claim 1, wherein the oil from the genetically modified oilseed crop plant comprises at least 7.5% to 26.2% w/w EPA, 0.7% to 8.2% w/w DHA and 3.5% to 10.4% DPA.

16. The method of claim 1, wherein the feed composition does not comprise more than 50% added marine oil.

17. The method of claim 1, wherein no more than 20% marine oil is present in the feed composition.

18. The method of claim 1, wherein the fish are salmonids.

19.-20. (canceled)

21. The method of claim 1, wherein the feed composition is powdered, flaked or pelleted.

22. The method of claim 21, wherein the powder or pellets are oil coated.
